(19) United States
(12) Patent Application Publication
(10) Pub. No.: US 2015/0158705 A1
(43) Pub. Date: Jun. 11, 2015

(54) TAG LINE EXTENSION

(71) Applicant: RISING FAST PTY LTD, Dawesville, Western Australia, WA (AU)

(72) Inventor: Shaun Cottone, Dawesville (AU)

(73) Assignee: RISING FAST PTY LTD, Dawesville, Western Australia, WA (AU)

(21) Appl. No.: 14/405,827

(22) PCT Filed: Jun. 5, 2013
(86) PCT No.: PCT/AU2013/000594

§ 371 Date: Dec. 5, 2014

(30) Foreign Application Priority Data
Jun. 5, 2012 (AU) 2012902383

(51) Int. Cl. B66C 13/08; B66C 15/00; B66C 13/06; B66C 13/04

(52) U.S. Cl. CPC B66C 13/08; B66C 13/04; B66C 15/00; B66C 13/06

(57) ABSTRACT

A tag line extension adapted to be attached to a load, the tagline extension comprising a rigid arm defining a base and a free end adapted to receive a tag line, the rigid arm being movable from a first position to a second, deployed position at which the free end of the rigid arm is located at a lateral distance from the load.

### FIELD OF THE INVENTION

The present invention relates to a tag line extension for the handling and manoeuvring of suspended loads, and in particular loads suspended from a crane. The present invention also relates to a method of handling loads using the tag line extension and to methods of fitting a tag line extension to a load.

### BACKGROUND TO THE INVENTION

Cranes and other lifting devices are often used to move large and heavy loads from one location to another. Typically, a crane has a jib, or working arm, that extends outwards, and from which a load is suspended by means of ropes or chains. The load may simply be the object to be moved—and to which the chains are removably attached—or the load can include a cage, platform, stillage, pallet or other suitable lifting device into, or onto, which is placed the object(s) to be moved.

To facilitate the manual handling of a suspended load a tag line can be attached to the load. This is depicted in FIG. 1 where the free end of a tag line 4 is attached to a suspended load 2 so it can be grasped by an operator 100 who, in co-operation with the operator of the lifting device, can then direct and control the load 2 as required while the load 2 is in the air. Conventionally, the tag line 4 is a rope dangling from the load 2. The problem with this approach is that the operator 100 will in many instances be standing directly under the load 2, particularly when the load is being lifted up or set down. This is extremely dangerous as the operator 100 could be injured or killed should the load 2 (or a part thereof) fall or the load 2 descends quickly while the operator 100 is in a vulnerable position.

The present invention seeks to address or at least partially ameliorate the problems discussed above in relation to the safe handling of suspended loads.

### SUMMARY OF THE INVENTION

The present invention provides a tag line extension adapted to be attached to a load, the tagline extension comprising a rigid arm defining a base and a free end adapted to receive a tag line, the rigid arm being movable from a first position to a second, deployed position at which the free end of the rigid arm is located at a lateral distance from the load.

The present invention also provides a tag line extension adapted to be attached to a load, the tagline extension comprising a rigid arm defining a base and a free end adapted to receive a tag line, the rigid arm being attachable to the load via an attachment means and being movable from a first position to a second, deployed position at which the free end of the rigid arm is located at a lateral distance from the load.

The present invention also provides a tagline extension for a load suspended from a crane, the tagline extension comprising: a rigid arm attached at one end to the load at point of attachment; and a free end for securing a tagline thereto, the rigid arm being movable from a first position to a second, deployed position in which the free end of the rigid arm is located at a lateral distance from the load.

The present invention also provides a method of deploying a tag line extension attached to a load and comprising a rigid arm, the method comprising the step of actuating the tag line extension so that a free end of the rigid arm is located at a lateral distance from the load.

The present invention also provides a method of maneuvering a load comprising the step of manually directing the load using a tag line extension according to the present invention.

The present invention also provides a method of preparing a load comprising the step of attaching a tag line extension according to the present invention to the load.

### BRIEF DESCRIPTION OF DRAWINGS

FIG. 1 is an illustration of the use of a prior art tag line for manoeuvring a load suspended from a crane;

FIG. 2 is a schematic illustration of a tag line extension of the present invention in a first, stowed position;

FIG. 3 is a schematic illustration of a tag line extension of the present invention in a second, deployed position;

FIG. 4 is a schematic illustration of the tag line extension of FIGS. 1 and 2 in use with a tag line attached;

FIG. 5A is a schematic illustration of an embodiment of a tag line extension of the present invention;

FIGS. 5B to 5D illustrate the component parts of the extension of FIG. 5A;

FIG. 6A is a schematic perspective view of another embodiment of the tag line extension of the present invention with rigid arm in a first stowed position;

FIG. 6B is a schematic perspective view of the tag line extension in FIG. 6A with the rigid arm in a second, deployed position;

FIG. 6C is a schematic side view of the tag line extension in FIG. 6A with the rigid arm in a first stowed position;

FIG. 6D is a schematic side view the tag line extension in FIG. 6A with the rigid arm in a second, deployed position;

FIG. 6E is a schematic plan view of the tag line extension in FIG. 6A with the rigid arm in a second, deployed position;

FIG. 7A is a schematic illustration of another embodiment of a tag line extension of the present invention attached to a load in the form of a container;

FIG. 7B is a front view of the bottom part or base of the rigid arm of the tag line extension of FIG. 7A;

FIGS. 7C and 7D are side views for the embodiment illustrated in FIG. 7B showing the rigid arm in deployed and stowed positions respectively;

FIG. 7E is a front view of the bottom part or base of the rigid arm of the tag line extension of the third embodiment of FIG. 7A with an alternative attachment means;

FIG. 7F is a side view for the embodiment illustrated in FIG. 7E;

FIG. 7G is a front view of the upper section or free end of the rigid arm of the tag line extension of FIG. 7A showing the eyelet and stowing mechanism;

FIGS. 8A and 8B illustrate another embodiment of the invention provided integrally with a lifting device;

FIGS. 9A, 9B and 9C illustrate a tag line extension housed within a protective channel, being a perspective, front and plan views respectively, with FIG. 9C being the plan view in the direction of arrow IX of FIG. 9B;

FIGS. 10A, 10B and 10C illustrate the use of a tag line extension according to one embodiment of the present invention on a stillage;

FIGS. 11A and 11B illustrate a tag line extension according to another embodiment of the present invention with an extendable, foldable arm;

FIG. 12 is a perspective view of a tag line extension according to another embodiment of the present invention housed in an alternative channel and includes an alternative securing means;

FIG. 13 is a perspective view of a tag line extension according to another embodiment of the present invention, similar to that depicted in FIG. 12 but incorporating a dedicated bracket mounting arrangement;

FIGS. 14A and 14B are two perspective views of the bracket depicted in FIG. 13; and

FIGS. 15A and 15B are two perspective views of a tag line extension according to another embodiment of the present invention, housed in an alternative channel including a strap based mounting arrangement.

### DETAILED DESCRIPTION OF THE INVENTION

According to an aspect the present invention provides a tag line extension adapted to be attached to a load, the tagline extension comprising a rigid arm defining a base and a free end adapted to receive a tag line, the rigid arm being movable from a first position to a second, deployed position at which the free end of the rigid arm is located at a lateral distance from the load.

Preferably, the rigid arm is pivotally movable from the first position to the second, deployed position. Even more preferably, the rigid arm is pivotally or hingedly movable about its base and around a fixed axis of rotation.

Preferably, the first position is a position in which the rigid arm is stowed.

The rigid arm can be extendable or otherwise adapted to allow for its length to be adjustable. For example, the rigid arm may be telescopic or include at least one joint that allows it to be folded upon itself to adjust its length. Preferably, the rigid arm comprises an upper and lower section hingedly connected together to allow for convenient adjustment of its length.

Preferably, the base of the rigid arm is adapted for pivotal or hinged movement insofar as it is capable of co-operating with a suitable bracket member for this movement. In this regard, the base of the rigid arm may comprise part of a hinge such as a hinge pin or hinge barrel and hence be adapted to engage with a respective compatible hinge part that is located on the load (when the tag line extension is directly attached to a load) or located on the attachment means (when the tag line extension is indirectly attached to a load). Preferably, the base of the rigid arm defines a hinge pin that is adapted to engage with a respective hinge barrel. The base of the rigid arm may define a “T” shape with the cross member or horizontal portion of the “T” forming the hinge pin.

Alternatively, the base of the rigid arm may define a “U” shape with one of the vertical portions of the “U” forming the hinge pin. In this form of the invention it will be appreciated that the “U” is oriented at 90° to the vertical such that it is essentially on its side and the vertical portions of the “U” are thus oriented horizontally.

In another embodiment of the invention the base of the rigid arm defines a hinge barrel that is adapted to engage with a respective hinge pin and hence allow for the required movement of the rigid arm between the first and second positions.

Preferably, the tag line extension includes a stop means to define the range of movement of the rigid arm between the first and second positions and hence define the second, deployed position.

When the rigid arm defines a hinge pin, the stop means may also be provided as part of the rigid arm and located at or towards its base. In this regard, the stop means may comprise at least one projection or lug that extends from the base of the rigid arm and is located so as to be adapted to abut with the load or the attachment means (described in more detail below) to define the second position of the rigid arm. When the base of the rigid arm defines a “U” shape (oriented at 90° to the vertical) the at least one projection or lug may be located on the vertical portion of the “U”, albeit oriented horizontally.

When the rigid arm defines a hinge barrel at the base of the arm that is compatible with a hinge pin mounted on the load, the stop means may be provided by an additional stop bar provided on or adjacent the hinge pin. To aid the operation of this form of the invention, the rigid arm may further comprise a stopping block which is positioned to abut with the stop bar when the rigid arm is in the second, deployed position. Preferably, the stopping block is made of a resilient material.

Preferably, the free end of the rigid arm includes a tag line receiving means such as an eyelet or loop for securing the tag line thereto. However, the free end of the rigid arm may be configured in any of a number of ways to receive the tag line.

As indicated above the tag line extension of the present invention can be attached to a load in a variety of ways provided the rigid arm is still capable of the required movement. At a general level the tag line extension can be directly attached to the load via the rigid arm itself being attached to the load or the tag line extension may further comprise an attachment means such as a housing that is attached to the load and the rigid arm is attached to the housing. However, regardless of the manner of attachment to the load, the general operation the tagline extension remains consistent. The description below mainly relates to the embodiment of the present invention including a housing, however, with respect to the operation of the rigid arm, it will be appreciated that the description and features may apply equally to embodiments where the rigid arm is attached directly to the load. In most situations, the only difference for embodiments that are directly attached to the load is that a feature described as being provided as part of the attachment means will be provided as part of the load.

Thus, the present invention also provides a tag line extension adapted to be attached to a load, the tagline extension comprising a rigid arm defining a base and a free end adapted to receive a tag line, the rigid arm being attachable to the load via an attachment means and being movable from a first position to a second, deployed position at which the free end of the rigid arm is located at a lateral distance from the load.

The attachment means allows for indirect attachment of the rigid arm to the load and may constitute a part of the tag line extension. Preferably, the attachment means is a housing that comprises a hinge part that is compatible with the hinge part provided on the rigid arm and thus for the attachment of the rigid arm and the required movement between the first and second positions. Thus, attachment means may comprise a hinge barrel or hinge pin.

In one form of the invention the attachment means comprises a housing that supports the hinge part and includes a base and at least two side walls where the base is adapted to be attached to the load and the side walls are adapted to support the hinge part. The housing may be sized to contain the entire length of the rigid arm and hence form a casing that surrounds the entirety of the rigid arm to support and protect the rigid arm.

Alternatively, the housing may be relatively small and simply surround the hinged connection.

The housing may comprise a stop means. In this regard, part of the housing may be configured to abut the rigid arm when in the second, deployed position and hence limit the range of pivotable movement of the rigid arm.

The housing may be adapted to be attached to the load by welding, bolting or some other permanent or semi-permanent attachment means.

Alternatively, the housing may be adapted to be attached temporarily to the load such as via straps or some other similar means that allow for more convenient removal of the tag line extension from the load.

When the attachment means is adapted to be attached temporarily to the load it may be adapted to temporarily attach to an additional bracket member that is adapted to be permanently or semi-permanently attach to the load. In this form of the invention rather than have the entire tag line extension permanently attached to a load, just the additional bracket member can be attached to the load and the tag line extension can be attached and detached from the additional bracket member (and hence the load) as required.

The additional bracket member may be varied provided it is capable of forming an attachment between the load and the tag line extension.

Alternatively, the housing may include a strap receiving means that enables the tag line extension to be strapped to a load. The strap receiving means may vary and includes at least one strap receiving bracket that may be positioned on the surface of the housing that, in use, is positioned adjacent the load.

Preferably, the tag line extension includes securing means for securing the rigid arm in the first position. The securing means may work with the tag line extension regardless of whether it includes an attachment means or not. In embodiments lacking an attachment means i.e. where the rigid arm is directly attached to the load, parts of the securing means will need to be provided as part of the load.

Preferably, the securing means comprises a locking pin for insertion into a pair of collinear apertures provided in a bracket, the bracket forming the attachment means, insertion of the locking pin in the pair of collinear securing the rigid arm in the first position.

Alternatively, the securing means is a hinged gate arranged to abut the rigid arm and retain it in the first position.

In another form of the invention, the securing means is a pin arrangement where the pin passes through the eyelet in the free end of the rigid arm to secure the rigid arm in the first position. Preferably, the pin is a drop lock pin.

The present invention also provides a tagline extension for a load suspended from a crane, the tagline extension comprising: a rigid arm attached at one end to the load at point of attachment; and a free end for securing a tagline thereto, the rigid arm being movable from a first position to a second, deployed position in which the free end of the rigid arm is located at a lateral distance from the load.

### General

Those skilled in the art will appreciate that the invention described herein is susceptible to variations and modifications other than those specifically described. The invention includes all such variation and modifications. The invention also includes all of the steps and features referred to or indicated in the specification, individually or collectively and any and all combinations or any two or more of the steps or features.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness. None of the cited material or the information contained in that material should, however be understood to be common general knowledge.

The present invention is not to be limited in scope by any of the specific embodiments described herein. These embodiments are intended for the purpose of exemplification only. Functionally equivalent products and methods are clearly within the scope of the invention as described herein.

The invention described herein may include one or more range of values (e.g. size etc). A range of values will be understood to include all values within the range, including the values defining the range, and values adjacent to the range which lead to the same or substantially the same outcome as the values immediately adjacent to that value which defines the boundary to the range.

Throughout this specification, unless the context requires otherwise, the word “comprise” or variations such as “comprises” or “comprising”, will be understood to imply the inclusion of a stated integer or group of integers but not the exclusion of any other integer or group of integers.

Other definitions for selected terms used herein may be found within the detailed description of the invention and apply throughout. Unless otherwise defined, all technical terms used herein have the same meaning as commonly understood to one of ordinary skill in the art to which the invention belongs.

### DESCRIPTION OF THE PREFERRED EMBODIMENTS

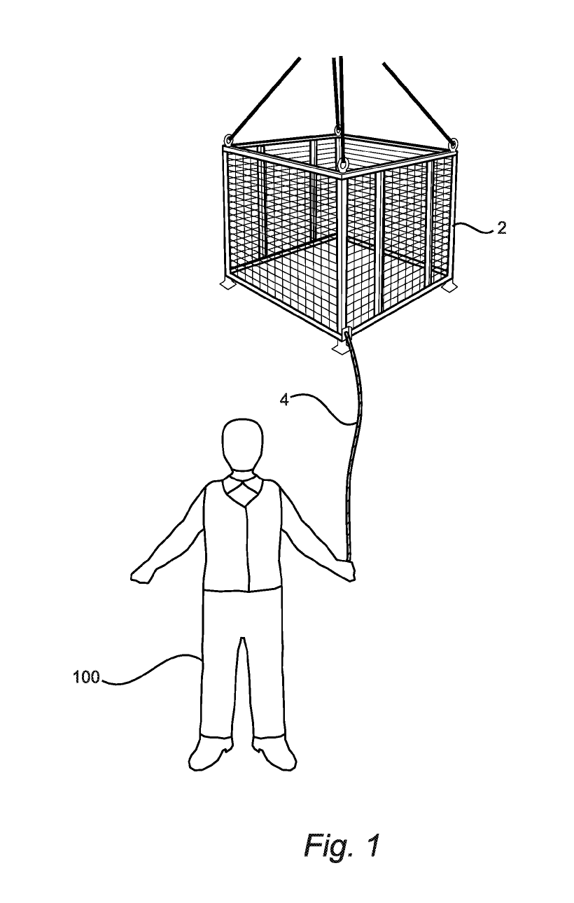

The present invention will now be described more fully hereinafter with reference to the attached drawings in which (with the exception of FIG. 1) certain preferred embodiments of the invention are shown. This invention may, however, be embodied in many different forms and should not be construed as limited to any of the embodiments set forth herein; rather, the embodiments are provided so that this disclosure will be thorough and complete, and will fully convey the scope of the invention to those skilled in the art.

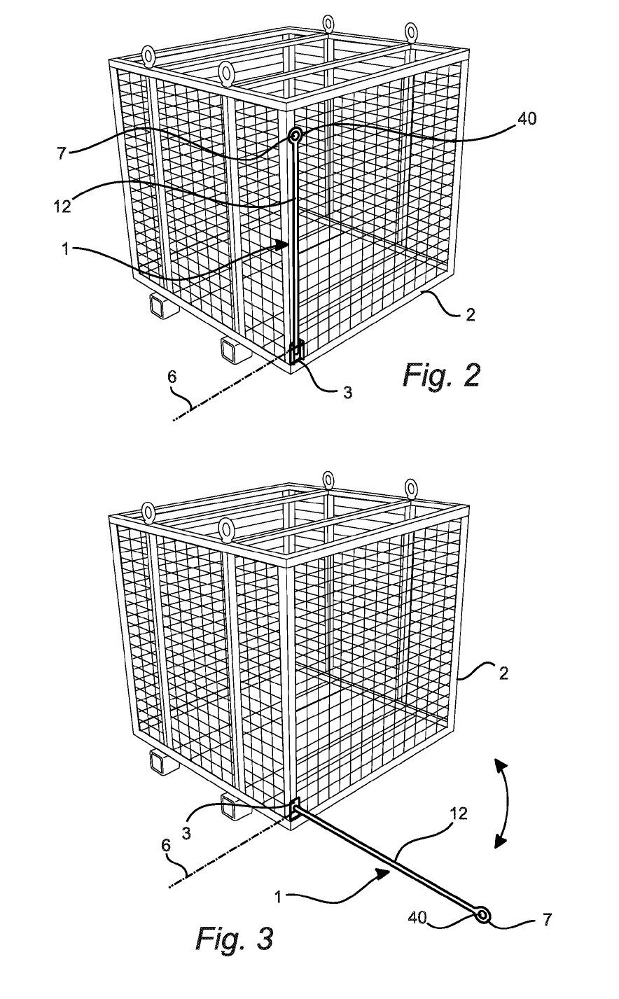

FIGS. 2-4 depict a tag line extension 1 according to one embodiment of the present invention adapted to be attached to a load in the form of a lifting device 2. In this embodiment, the tag line extension 1 is attached to a lifting device 2 in the form of a cage, but any other suitable lifting device can be used such as a pallet, stillage or platform. The lifting device 2 is used to contain or support materials that are required to be moved from one location to another as is well known to persons skilled in the art. The lifting device 2, along with any materials or objects which may be contained therein or thereon, comprise a load which is required to be moved. The lifting device 2 may be empty in many instances so the load in this instance is simply the lifting device 2. The lifting device 2 is suspended from a crane's jib (not shown) using chains, ropes or other suitable means as is well known.

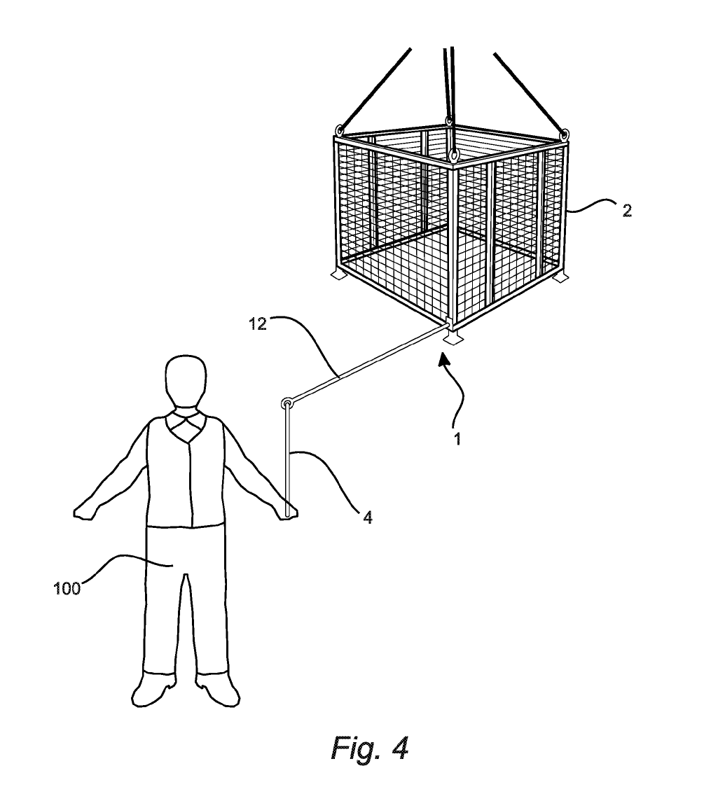

The tag line extension 1 comprises a rigid arm 12 adapted to be attached at its base to the lifting device 2 via an attachment means in the form of a housing 3. The tag line extension is also adapted to removably receive a tag line 4 in a tag line receiving means in the form of eyelet 40 in its free end 7—see FIG. 4.

In the present invention, the housing 3 enables the tag line extension 1 to be permanently attached to the load 5 and facilitates pivotable movement of the rigid arm 12 around an axis of rotation 6 at a point of attachment between the tag line extension 1 and the lifting device 2 as will be described in further detail below. The double-headed arrow in FIG. 3 indicates the pivoting motion of the rigid arm 12.

Because the rigid arm 12 is pivotable around the axis of rotation 6, the rigid arm 12 is pivotable between a first position in which the rigid arm 12 is stowed against the side of the lifting device 2 (see FIG. 2) and a second, deployed, position in which the rigid arm 12 is extended away from the lifting device 2 so that the free end 7 of the rigid arm 12 is at a lateral distance from the load (see FIG. 3). The rigid arm 12 is preferably stowed when the lifting device 2 is not in use.

FIG. 3 shows the rigid arm 12 in the second, deployed position in which the free end 7 is laterally displaced from the load. The housing 3 includes a stop means (not shown) to ensure that the range of pivot of the rigid arm 12 is restricted or limited so that the rigid arm 12 cannot pivot beyond a predetermined position or limit. The form of this stop means will vary depending upon the embodiment and a number of different embodiments are described in more detail below.

In a preferred embodiment, this second, deployed, position is one in which the rigid arm 12 is extended in a substantially horizontal position so that the lateral displacement of the free end 7 of the tag line extension 1 relative to the load is maximised—see FIG. 3. In this way, the angular displacement from the first to second position is substantially 90 degrees, although it may be slightly more or less than 90 degrees in some embodiments, depending upon the position of the stop means

As can be seen in FIG. 4, when the rigid arm 12 is in the second deployed position, the tag line 4 hangs down at a distance laterally displaced from the load. In this way, an operator 100, when holding the tag line 4 to manoeuvre the load, is able to do so without standing in a vulnerable place underneath the load while it is being manoeuvred.

The rigid arm 12 can be retained in the first, stowed position using a securing means depending upon the embodiment of the invention.

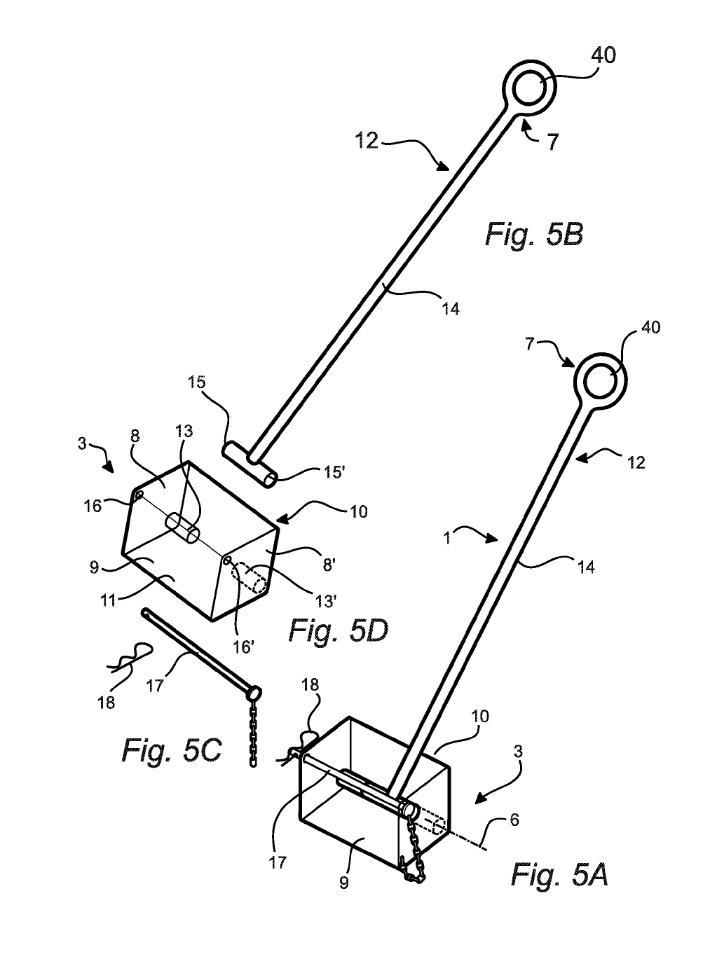

FIGS. 5A to 5D illustrate another embodiment of a tag line extension of the present invention incorporating a particular housing arrangement.

As in FIGS. 2-4, the tag line extension 1 in FIGS. 5A-5D comprises a rigid arm 12 attached at one end to the housing 3. The rigid arm 12 is “T” shaped and adapted for hinged movement and comprises an elongate body portion 14 with the eyelet 40 at one end which forms the free end 7. The other end is the base that defines a hinge pin in the form of a pair of perpendicularly-extending cylindrical projections 15, 15′ forming the horizontal part of the T-shape.

Cylindrical projections 15, 15′ are adapted to engage with a respective hinge barrel in the form of inwardly-extending collinear tubular lugs 13, 13′ located in the attachment means 3 in the form of a bracket or cradle 10 comprising an L-shaped mount 11 with side walls 8, 8′. The mount 11 is used to secure the tag line extension 1 to the lifting device 2. This is best shown in FIG. 5A. Thus, the collinear lugs 13, 13′ serve to define the pivot axis 6 around which the rigid arm 12 rotates.

A pair of collinear apertures 16, 16′ are also provided in the side walls 8, 8′ (see FIG. 5D). These collinear apertures 16, 16′ are arranged to receive a locking pin 17 therethrough which is retained in place by a suitable securing means 18 such as a spring retainer. The locking pin 17 is attached to the bracket 10 by means of a leash in the form of a chain 19 (see FIGS. 5A and 5C) or other suitable means such as wire or a cord could be used. The locking pin 17 and securing means in the form of clip 18 comprise one form of a securing means for holding the rigid arm 12 in the first, stowed position depicted in FIG. 2. When moving the rigid arm 12 to the second, deployed position, the clip 18 is removed so that the locking pin 17 can be removed from the collinear apertures 16, 16′ which allows the rigid arm 12 to rotate and thus the rigid arm 12 can then be deployed.

The base 9 of the mount 11 serves as the stop means to restrict pivoting movement of the rigid arm 12 as the rigid arm 12 will be prevented from further movement when it abuts the base 9.

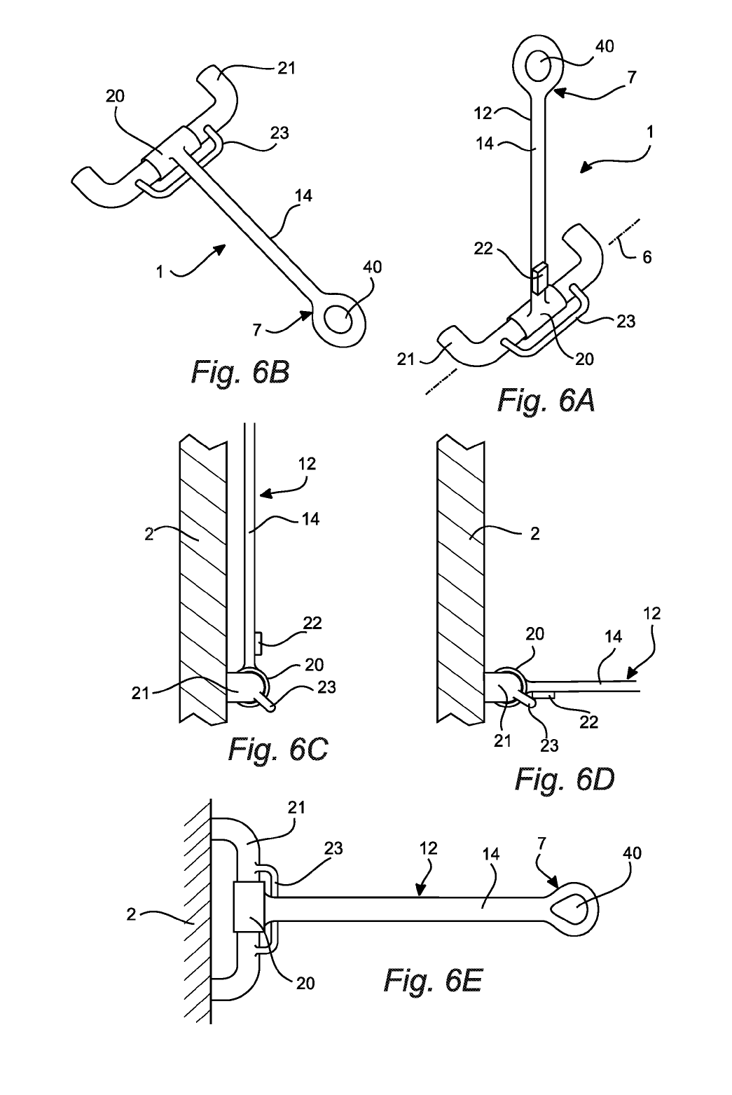

FIGS. 6A to 6E illustrate another embodiment for the tag line extension 1. Where features are the same as those in previous embodiments, then the same numbering is used.

In this embodiment, the attachment means comprises a U-shaped bar 21 which defines a hinge pin and is attached to the lifting device 2. The base of the rigid arm 12 defines a hinge barrel in the form of a tubular portion 20 for receiving the compatible hinge pin defined by the cross member of the U-shaped bar 21 therein (see FIG. 6A). In this way, the axis of rotation 6 is defined by the tubular portion 20 and the cross member of the U-shaped bar 21.

The U-shaped bar 21 further comprises a stopping means in the form of an additional stop bar 23 which operates as the stop means for restricting rotation of the rigid arm 12 around the axis of rotation 6 as shown in FIGS. 6C and 6D. The rigid arm 12 is also provided with a stopping block 22 which abuts the stop bar 23. The stopping block 22 is made of a resilient material that cushions the impact of the rigid arm 12 against the stop bar 23.

The rigid arm 12 can be secured in the stowed position using any suitable means such as the gate or pin described herein.

Another embodiment of the invention is designed for use with a load in the form of a container, such as a shipping container. Again, where features are the same as those in previous embodiments, then the same numbering is used.

The tag line extension 1 is designed to be attached to a container 24, for example, in the recessed side panels 26 in the side 27 of the container 24.

The tag line extension 1 again comprises a rigid arm 12 having an elongate body portion 14 with an eyelet 40 at its free end 7. The base of the rigid arm defines a “U” shape with one of the vertical portions of the “U” 30 forming the hinge pin. In this form of the invention it will be appreciated that the “U” is oriented at 90° to the vertical such that it is essentially on its side and the vertical portions of the “U” are thus oriented horizontally.

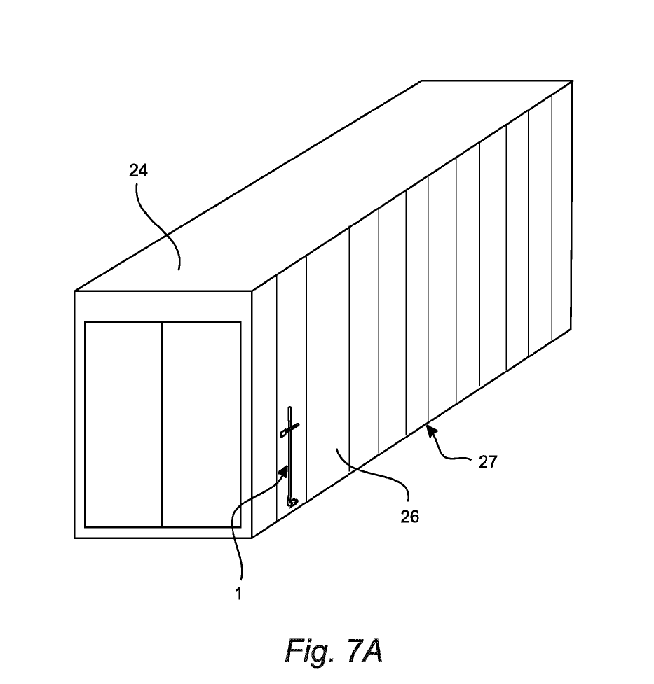

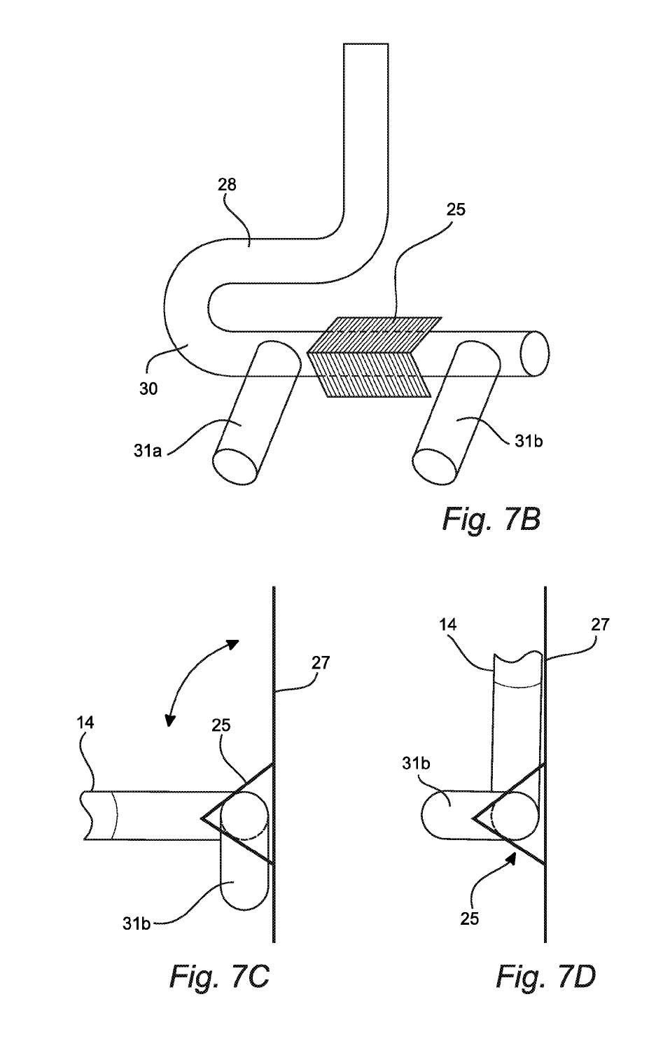

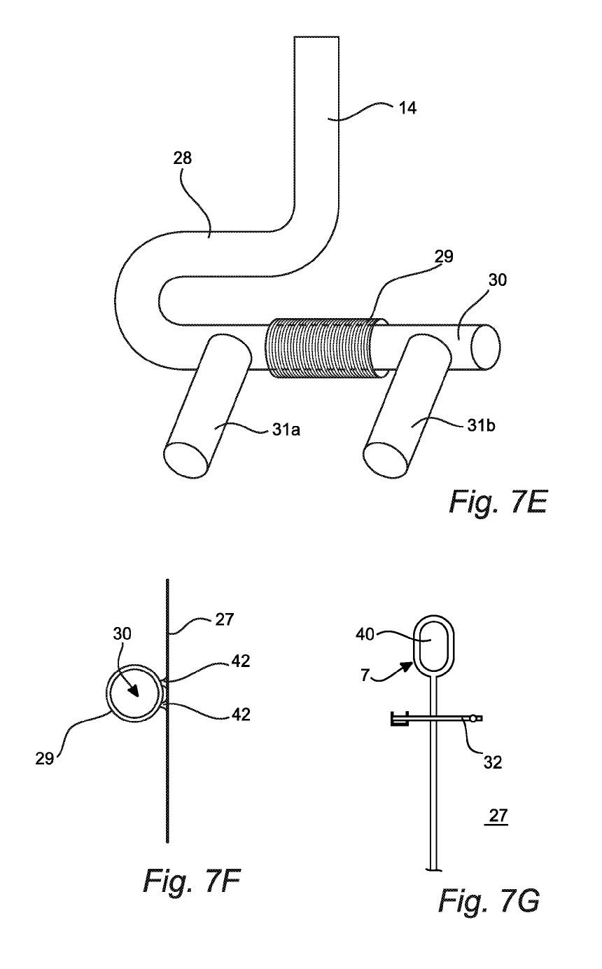

The attachment means is provided as an angled bracket 25 that forms a hinge barrel and is used to attach the rigid arm 12 to the container 24. As can be seen in FIG. 7B, the angled bracket 25 is secured to the container 24 at an appropriate part of a side panel 27 with the section 30 of the rigid arm 12 received within. The rigid arm 12 is able to pivot around the axis of rotation defined by the longitudinal axis of the returning section 30.

The stop means is in the form of a pair of stopping lugs 31a, 31b that extend in the same plane as each other and substantially at right angles from the section 30. As illustrated in FIGS. 7C and 7D, as the rigid arm 12 moves from the stowed position (FIG. 7D) to the deployed position (FIG. 7C), the pair of stopping lugs 31a, 31b abut the side 27 of the container 24 thereby limiting the amount of rotation around the axis of rotation 6.

In this embodiment, the rigid arm 12 and the eyelet 40 is flattened in cross-section to keep it narrow and thus able to fit within the recessed side panel 26. This is illustrated separately in FIG. 7G for clarity.

To retain the rigid arm 12 in the first, stowed position, the securing means is in the form of a hinged locking gate or pin 32—see FIG. 7G.

Typically, the rigid arm 12 and lugs 31a, 31b have a diameter of around 16 mm. The angled bracket 25 is 25 mm by 25 mm.

In an alternative arrangement depicted in FIGS. 7E and 7F, the angled bracket 25 is replaced by another hinge barrel in the form of a tubular sleeve 29 which can be welded to recessed panels 26 of the side 27 of the container 24 at weld points 42. The section 30 of the base of the rigid arm that forms the hinge pin is received within the sleeve 29 for rotation therein. The tubular sleeve 29 is dimensioned to snugly receive the section 30.

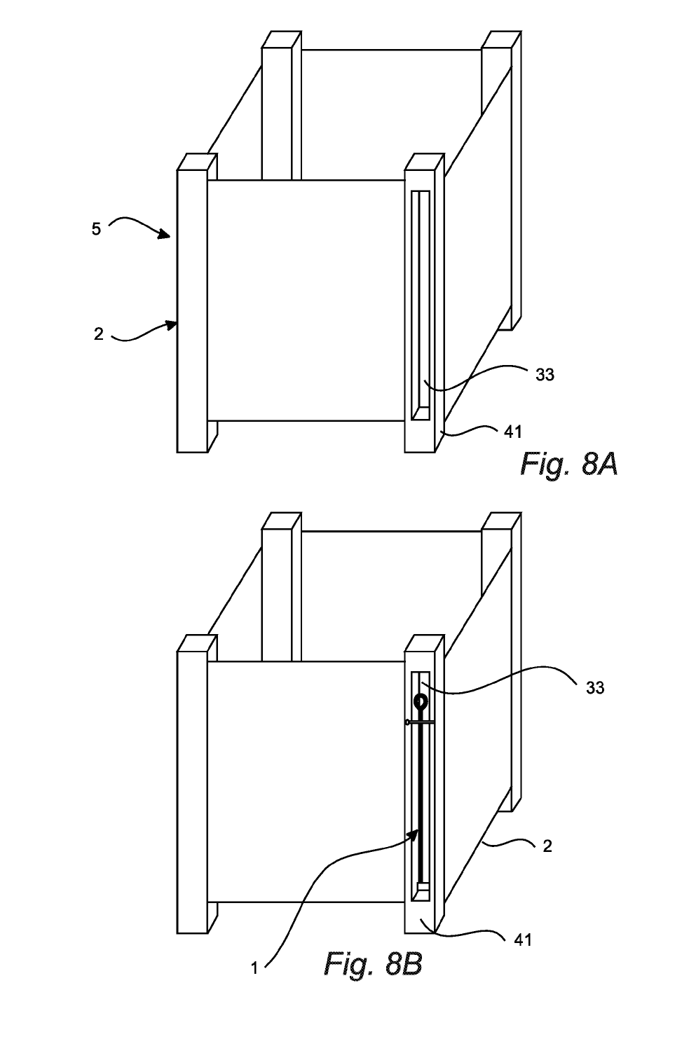

In another embodiment, the tag line extension 1 can be integrated into the body of a lifting device 2, for example, in the legs 41 of the lifting device 2. This embodiment is shown in FIGS. 8A and 8B in which the tag line extension 1 is provided in a recess 33 in one of the legs 41 of a lifting device 2. The tag line extension 1 can be of any suitable arrangement as described above in respect of other embodiments, and can be secured in the first position for example using the locking pin arrangement of the first embodiment, or using a locking gate or pin 32 (see FIG. 8B).

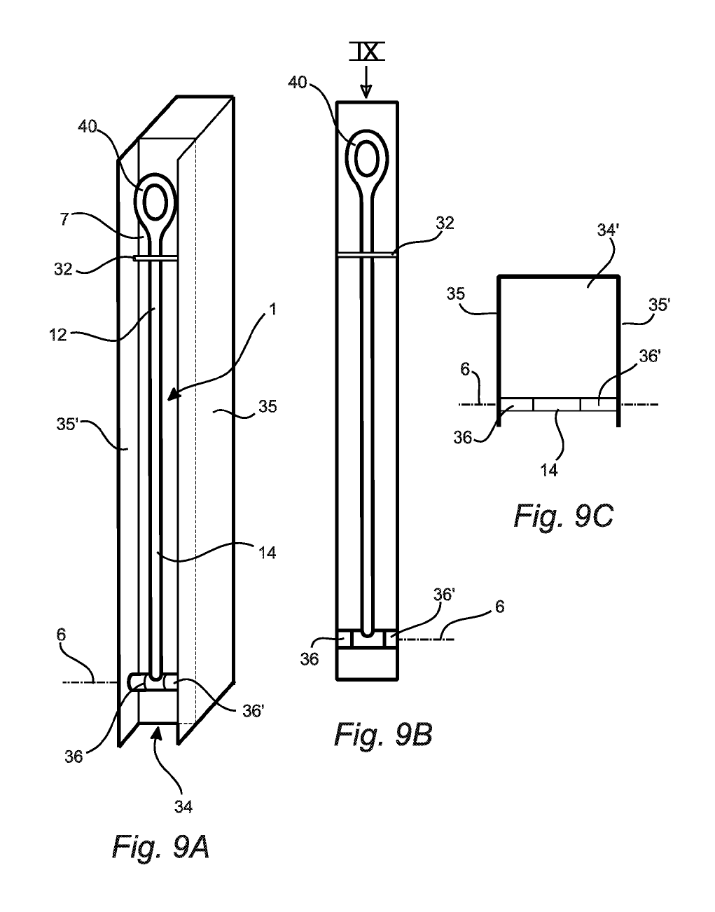

According to another embodiment, the tag line extension 1 can be provided with an attachment means in the form of a housing that supports the hinge part and is sized to contain the entire length of the rigid arm 12. This embodiment is depicted in FIGS. 9A-9C where the housing is in the form of an elongate channel 34 having side walls 35, 35′. The elongate channel 34 is adapted to be fixed to the lifting device 2 and acts to provide protection for the tag line extension 1 supported therein. The rigid arm 12 can be mounted in the elongate channel in a similar way to the manner in which the rigid arm 12 is mounted with respect to the other embodiments described above. For example, using collinear tubular lugs 36, 36′ to receive perpendicular projections 37, 37′ of the rigid arm 12. This is shown in FIGS. 9A, 9B and 9C. Thus, the collinear lugs 36, 36′ serve to define the axis 6 which the rigid arm 12 pivots.

A securing means in the form of a gate 32 is provided as with the embodiment illustrated in FIG. 7G.

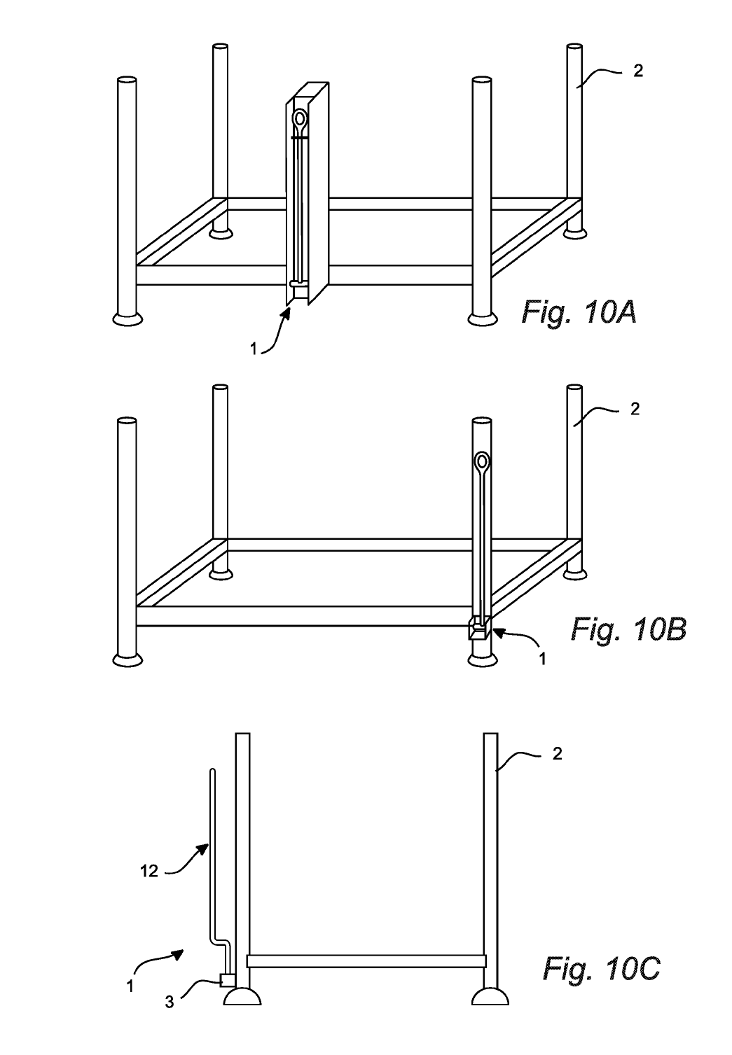

FIGS. 10A, 10B and 10C schematically illustrate the use of the tag line extension 1 of the present invention with a stillage: using a channel 34 to store the extension 1 therein and attach the extension 1 to the load in the form of a stillage (FIG. 10A), or using a tag line extension according to the first embodiment described above (FIGS. 10B and 10C). If the stillage has lifting chains (not shown), the rigid arm 12 can be bent at an appropriate point to accommodate these chains—see FIG. 10C.

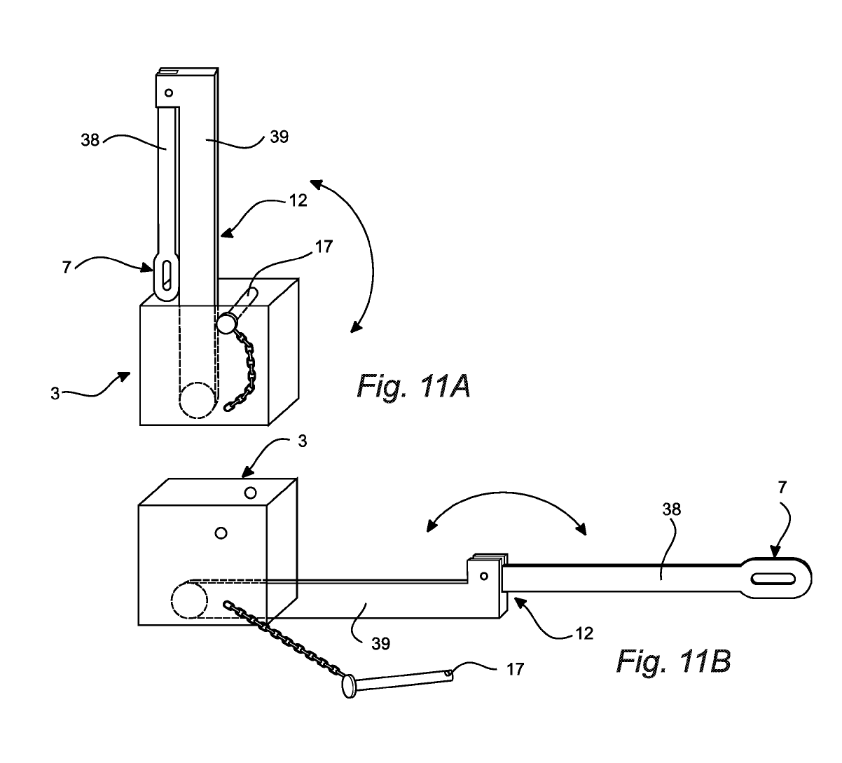

For situations where there is limited space in which to stow the rigid arm 12 in the first position, the rigid arm 12 can be provided in two parts so that it can be stowed in a folded arrangement. This is illustrated schematically in FIGS. 11A and 11B.

The arrangement is similar to that described above with respect to FIGS. 5A to 5D, but, in this embodiment, the rigid arm 12 is in two parts—an upper part 38 and a lower part 39 which are hinged together at a point along the length of the rigid arm 12. When the rigid arm 12 is in the first, stowed position, the upper part 38 can be pivoted through 180 degrees into a retracted position in which it is located against the lower part 39. It is thus of a shorter length for stowing. In the second, deployed position, the upper part 38 can be rotated through 180 degrees to an extended position. In an alternative, the upper part 38 and lower part 39 can be provided in a telescoping arrangement.

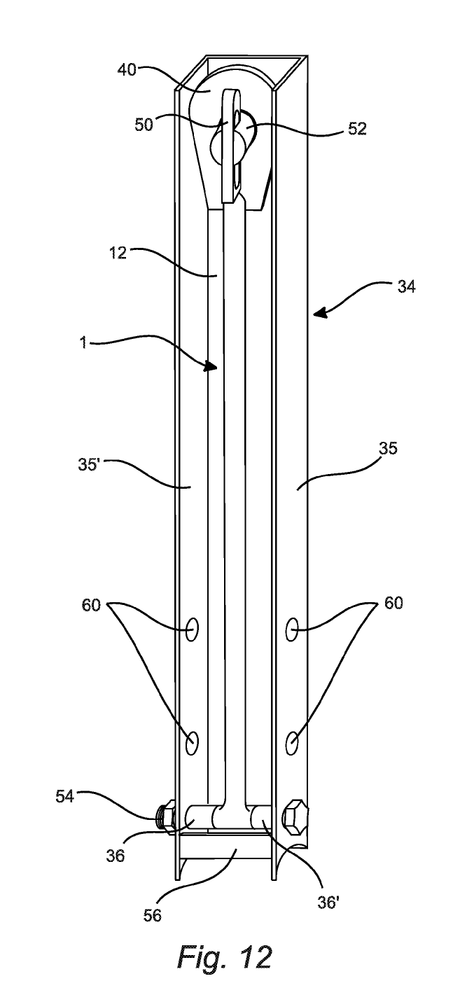

FIG. 12 depicts another embodiment similar to that depicted in FIGS. 9A-9C. The tag line extension 1 according to this embodiment is provided in a housing that supports the entire length of the rigid arm 12. The housing is in the form of an elongate channel 34 having side walls 35, 35′. The elongate channel 34 is adapted to be fixed to the lifting device 2 by bolting through bolt holes 60 or some other similar means and acts to provide protection for the tag line extension 1 supported therein. The rigid arm 12 is mounted in the elongate channel using a hinge barrel at the base of the rigid arm 12 and co-linear tubular lugs 36, 36′ through which pass a bolt 54 to allow the rigid arm to be pivotally mounted.

The stop means is in the form of a bar 56 that extends across the channel 34 below the mounting point for the rigid arm 12. As the rigid arm 12 moves from the stowed position to the deployed position the bar 56 abuts the rigid arm thereby limiting the amount of rotation around the axis of rotation 6.

A securing means in the form of a drop lock pin 50 and post 52 is provided to secure the tag line extension in the first position. The post 52 being shaped so as to fit within eyelet 40 and be held in place by the drop lock pin 50. Removal of drop lock pin 50 allows the rigid arm 12 of the tag line extension 1 to be deployed.

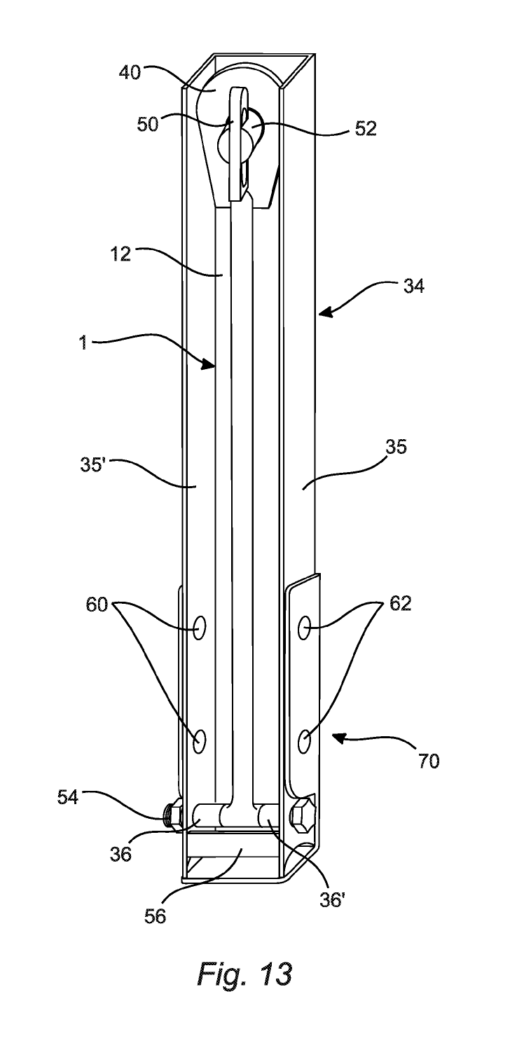

FIG. 13 depicts another embodiment similar to the embodiment depicted in FIG. 12. The main difference being that the tag line extension 1 according to this embodiment also includes an additional bracket member in the form of bracket 70 to facilitate the attachment of the tag line extension to a load. The bracket 70 is adapted to be attached to the channel via bolt holes 62 that, when fitted, are co-linear with bolt holes 60 the side walls 35, 35′ in the channel 34. When in use, rather than removing the entire assembly from a load, the channel 34 housing the tag line extension 1 can be removed and the bracket 70 can be left in place on the load.

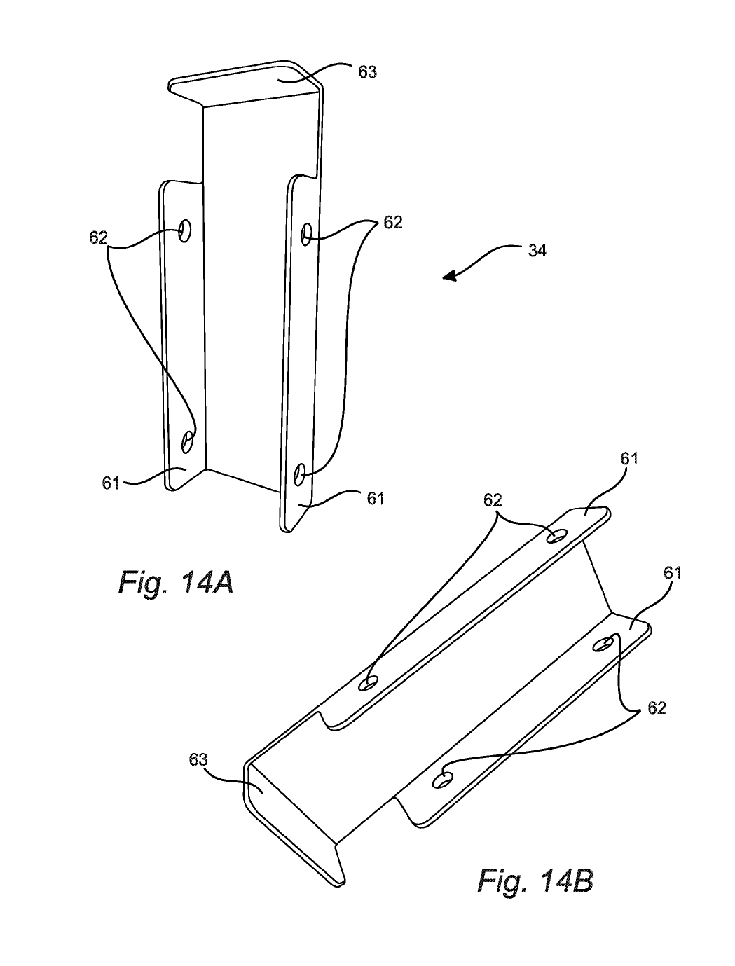

FIGS. 14A and 14B depicts the bracket 70 from FIG. 13. The bracket 70 includes side walls 61 that include bolt holes 62 positioned so as to be co-linear with corresponding bolt holes in the channel 34 when fitted thereon. another embodiment similar to the embodiment depicted in FIG. 12. The bracket 70 is configured and sized to fit snugly over the outside of a portion of the channel 34 and also includes a lip 63 that extends across the open of the channel 34 to cover and protect the pivotal mounting arrangement of the rigid arm 14.

The bracket 70 is adapted to be attached to the channel via bolt holes 62 that, when fitted, are co-linear with bolt holes 60 the side walls 35, 35′ in the channel 34. When in use, rather than removing the entire assembly from a load, the channel 34 housing the tag line extension 1 can be removed and the bracket 70 can be left in place on the load.

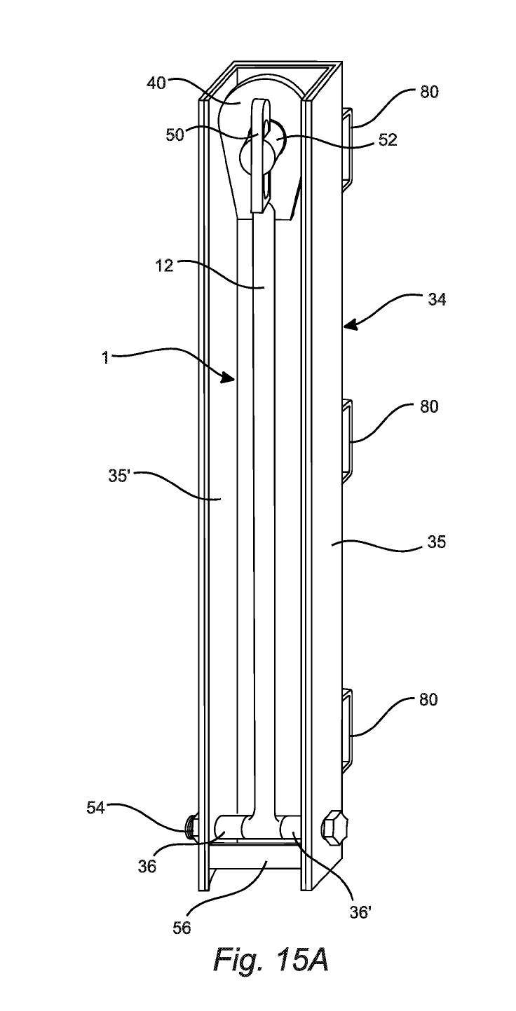

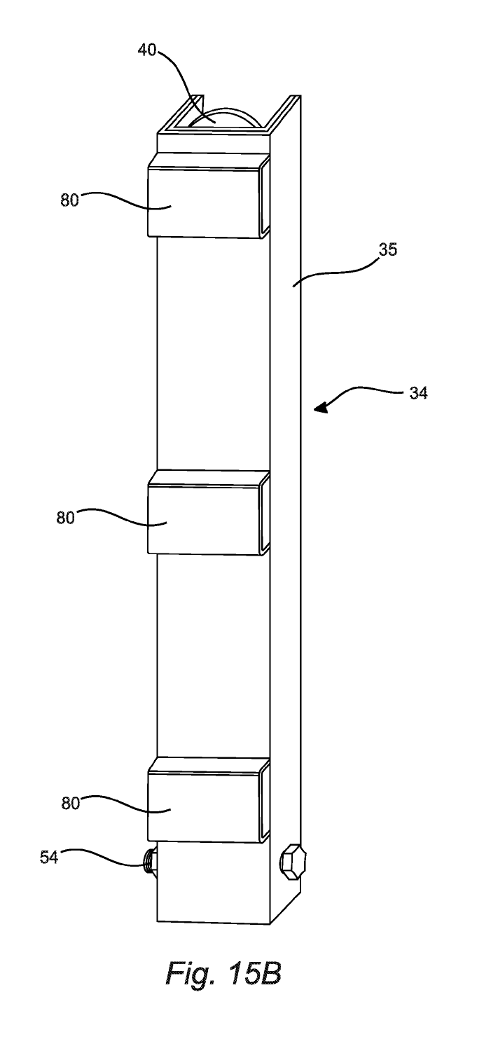

FIGS. 15A-15B depicts another embodiment similar to the embodiment depicted in FIG. 12. The main difference being that the tag line extension 1 according to this embodiment is adapted to be strap mounted to load and includes a strap receiving means in the form strap receiving brackets 80 provided on the rear surface of the channel 34. In use, straps or some other similar member can be passed through the strap receiving brackets 80 and thus attach the tag line extension 1 to the load. Other components are the same (and corresponding numbering has been used) as those depicted in FIG. 12.

The rigid arm can be made from any suitable material such as steel, aluminium, high strength plastics materials, carbon, or any other suitable material depending upon the environment and the intended use.

The tag line extension can be manufactured so as to be non-conductive to electricity. This can be achieved through the choice of materials for manufacturing the product or through treating the product with non-conductive material. One example is the use of rubber (or some other non-conductive material) sleeves over at least part of the tag line extension that can be provided for added protection against electrical hazards.

High visibility coatings can be used for easy identification and locating.

The attachment means can be secured to the lifting device by bolting, by welding or any other suitable means. The securing means can be provided by latches, magnets, spring loaded barrel bolts, magnets or any other suitable means.

Modifications are possible within the scope of the present invention. For example, other combinations of the different embodiments described herein may be possible. Rather than a pivot a ball-and-socket joint can be utilised for additional flexibility.

1-34. (canceled)

35. A tag line extension adapted to be attached to a load, the tagline extension comprising a rigid arm defining a base and a free end adapted to receive a tag line, the rigid arm being movable from a first position in which it is stowed to a second, deployed position at which the free end of the rigid arm is located at a lateral distance from the load.

36. The tag line extension according to claim 35, wherein the rigid arm is pivotally movable from the first position to the second, deployed position.

37. The tag line extension according to claim 35, wherein the rigid arm is hingedly movable about its base and around a fixed axis of rotation.

38. The tag line extension according to claim 35, wherein the rigid arm has an adjustable length.

39. The tag line extension according to claim 38, wherein the rigid arm is telescopic or includes at least one joint that allows it to be folded upon itself to adjust its length.

40. The tag line extension according to claim 35, wherein the base of the rigid arm is adapted for pivotal or hinged movement.

41. The tag line extension according to claim 40, wherein the base of the rigid arm comprises part of a hinge such as a hinge pin or hinge barrel.

42. The tag line extension according to claim 35, further comprising a stop means to define the range of movement of the rigid arm between the first and second positions and hence define the second, deployed position.

43. The tag line extension according to claim 35, wherein the free end of the rigid arm includes a tag line receiving means.

44. The tag line extension according to claim 43, wherein the tag line receiving means is an eyelet or loop for securing a tag line thereto.

45. The tag line extension according to claim 35, wherein the rigid arm is attachable to the load via an attachment member.

46. The tag line extension according to claim 45, wherein the attachment member is a housing that comprises a first hinge part that is compatible with a second hinge part provided on the rigid arm.

47. A tag line extension according to claim 46, wherein the housing supports the first hinge part and includes a base and at least two side walls and wherein the base is adapted to be attached to the load and the side walls are adapted to support the first hinge part.

48. A tag line extension according to claim 46, wherein the housing contains the entire length of the rigid arm.

49. A tag line extension according to claim 46, wherein the housing further comprises a stop means to define the range of movement of the rigid arm between the first and second positions and hence define the second, deployed position.

50. A tag line extension according to claim 45, wherein the attachment member comprises an additional bracket member that is adapted to be permanently or semi-permanently attach to the load.

51. A tag line extension according to claim 45, wherein the attachment member includes a strap receiving means that enables the tag line extension to be strapped to a load.

52. The tag line extension according to claim 35, further comprising a securing means for securing the rigid arm in the first position.

53. The tag line extension according to claim 52, wherein the securing means comprises a locking pin for insertion into a pair of co-linear apertures provided in a bracket, the bracket forming the attachment means and where insertion of the locking pin in the pair of co-linear apertures secures the rigid arm in the first position.

54. The tag line extension according to claim 52, wherein the securing means is a hinged gate arranged to abut the rigid arm and retain it in the first position.

55. The tag line extension according to claim 52, wherein the securing means is a pin arrangement where the pin passes through the eyelet in the free end of the rigid arm to secure the rigid arm in the first position.

56. The tag line extension according to claim 55, wherein the pin is a drop lock pin.
